(19) United States
(12) Patent Application Publication
(10) Pub. No.: US 2003/0028393 A1
(43) Pub. Date: Feb. 6, 2003

(54) Method and computer program for estimating project costs and time factors and facilitating management of remodeling and construction projects

(76) Inventors: Robert Michael Coulston, Kansas City, MO (US); Dean Alden Blay, Kansas City, MO (US); Keith Alden Blay, Kansas City, MO (US)

Correspondence Address: THOMAS B. LUEBBERING, HOVEY WILLIAMS LLP, Suite 400, 2405 Grand, Kansas City, MO, 64108, US

(21) Appl. No.: 10/174,179

(22) Filed: Jun. 18, 2002

Related U.S. Application Data
(60) Provisional application No. 60/298,924, filed on Jun. 18, 2001.

(51) Int. Cl. G06F 17/60

(52) U.S. Cl. 705/1; 705/400; 705/30

(57) ABSTRACT

A method and computer program for estimating project costs and time factors and facilitating project management, wherein the project concerns remodeling or construction or a similar endeavor, and the management thereof involves estimating material and labor costs for each phase of the project; contract generation incorporating the estimate, special terms or conditions, and standard contract language; and procurement of materials and services, including subcontractor services, and scheduling of deliveries and labor, including hourly workers. The computer program comprises a number of cross-platform, fully-integrated subprograms and databases, including an Estimator Subprogram; a Materials Database; a Contract Subprogram; a Production Subprogram; a Worker Database; a Subcontractor Database; and a Vendor Database. Each subprogram is operable to, as needed import and incorporate data entered into or generated by the other subprograms and databases.

### RELATED APPLICATIONS

This application claims priority benefit, with regard to all common subject matter, of the filing date of a provisional application titled “Project Management Program”, Ser. No. 60/298,924, filed Jun. 18, 2001. The identified provisional application is hereby incorporated by reference as though set forth in its entirety herein.

### COMPUTER PROGRAM LISTING APPENDIX

A computer program listing appendix containing the source code of a computer program that may be used with the present invention is incorporated herein by reference and appended hereto as one (1) original compact disk, and an identical copy thereof, containing a total of thirty (30) files as follows:

| Date of Creation | Size (Bytes) | Filename |
|---|---|---|
| 06/18/02 10:41a | 29,917 | CARPEN˜1 |
| 06/18/02 10:41a | 11,189 | CHANGE˜1 |
| 06/18/02 10:42a | 13,679 | CONTRA˜1 |
| 06/18/02 10:44a | 26,366 | ES4D9D˜1 |
| 06/18/02 10:44a | 12,539 | ES5D9D˜1 |
| 06/18/02 10:44a | 17,047 | ES6D9D˜1 |
| 06/18/02 10:45a | 12,970 | ES7D9D˜1 |
| 06/18/02 10:45a | 28,533 | ES8D9D˜1 |
| 06/18/02 10:45a | 19,305 | ES8EC9˜1 |
| 06/18/02 10:45a | 20,682 | ES8ED9˜1 |
| 06/18/02 10:45a | 21,095 | ES8EE9˜1 |
| 06/18/02 10:42a | 24,415 | ESTIMA˜1 |
| 06/18/02 10:43a | 9,140 | ESTIMA˜2 |
| 06/18/02 10:43a | 18,786 | ESTIMA˜3 |
| 06/18/02 10:44a | 23,529 | ESTIMA˜4 |
| 06/18/02 10:46a | 12,487 | MATERI˜1 |
| 06/18/02 10:46a | 23,733 | MATERI˜2 |
| 06/18/02 10:47a | 13,288 | MATERI˜3 |
| 06/18/02 10:47a | 21,186 | MATERI˜4 |
| 06/18/02 10:47a | 16,180 | MRB8AD˜1.REM |
| 06/18/02 10:48a | 21,060 | PRODUC˜1 |
| 06/18/02 10:48a | 16,281 | PRODUC˜2 |
| 06/18/02 10:49a | 2,353 | PRODUC˜3 |
| 06/18/02 10:49a | 6,196 | SALESM˜1 |
| 06/18/02 10:49a | 16,028 | SALESM˜2 |
| 06/18/02 10:50a | 7,633 | SALESM˜3 |
| 06/18/02 10:50a | 16,526 | SUBLIS˜1 |
| 06/18/02 10:51a | 19,042 | SUBLIS˜2 |
| 06/18/02 10:51a | 17,389 | VENDOR˜1 |
| 06/18/02 10:51a | 19,308 | VENDOR˜2 |

### BACKGROUND OF THE INVENTION

1. Field of the Invention

The present invention relates broadly to tools for estimating project costs and time factors and facilitating project management. More particularly, the invention relates to a method and computer program for estimating project costs and time factors and facilitating project management, wherein the project concerns construction or remodeling or a similar endeavor, and the management thereof involves estimating material and labor costs; generating a contract, change order, or other legal agreement incorporating the estimate, any special terms or conditions, and standard contract language; and procuring materials and necessary services, including and subcontractor services, and scheduling deliveries and labor, including hourly workers.

2. Description of the Prior Art

In the remodeling and construction industries, it will be appreciated that many projects evolve as follows: first, a list of materials and labor is created; then a cost and time factor estimate is prepared; then a contract or other legal agreement is prepared; and, lastly, materials are ordered, subcontractors are scheduled, and labor and deliveries are scheduled. It is often desirable to use computerized tools for facilitating project management by providing standardization without which cost estimation and production scheduling must rely on hard-won experience or guesswork. Such standardization results in increased accuracy and efficiency which reduces or eliminates low estimates and wasted time, which, in turn, advantageously results in a more consistent profit margin.

Unfortunately, existing tools are typically not comprehensive or fully-integrated, requiring instead that a number of otherwise disparate tools be costly and inefficiently custom-integrated to form a patchworked package of needed functions. Without such integration, data must be redundantly entered, thereby compounding inefficiency and error risks. Many of these existing tools are generic and are not designed with the peculiarities and unique needs of the remodeling and construction industry in mind. Thus, patchwork custom-integration of existing generic tools typically captures only the broadest advantages of full integration because the tools are typically only integratable to the point of sharing data at a very high level. This precludes creating fully-integrated industry-specific features.

Additionally, existing tools typically suffer from a number of other disadvantages, including that they are typically not sufficiently flexible or modifiable to accommodate a substantial variety of cost issues, working conditions, local laws, and other considerations.

Due to these and other problems and disadvantages in the art, an improved tool is needed for estimating project costs and time and facilitating project management.

### SUMMARY OF THE INVENTION

The present invention overcomes the above-described and other problems and disadvantages by providing a method and computer program for estimating project costs and time factors and facilitating project management, wherein the project concerns construction or remodeling or a similar endeavor, and the management thereof involves estimating material and labor costs; generating a contract or other legal agreement incorporating the estimate, any special terms or conditions, and standard contract language; and procuring the materials and necessary services, including subcontractor services, and scheduling deliveries and labor, including hourly workers.

In a preferred embodiment, the method of project management is implemented as the computer program comprising a number of cross-platform, fully-integrated subprograms and databases, including an Estimator Subprogram; a Materials Database; a Contract Subprogram; a Production Subprogram; a Worker Database; a Subcontractor Database; and a Vendor Database.

The Estimator Subprogram is operable to access the Materials Database to provide a spreadsheet-type list of material and labor items from which particular items necessary for completion of the project may be selected. Individual items may be selected or common assemblies comprising multiple items may be selected. Each item or assembly is associated with a unit cost, a labor cost, and a total item cost. The result of such selections is a list of required items and a total cost estimate associated therewith.

The Estimator Subprogram advantageously provides for maximum modifiability of desirably variable factors related to generating the estimate, such as, for example, unit cost, wage rate, gross profit margin (GPM), mark-up, local taxes, production time factors (in hours, minutes, and seconds, where appropriate), material prices, or unique job conditions, thereby making the present invention flexible and adaptable to varying project conditions and locales. This flexibility accommodates such situations as, for example, where entire projects or portions thereof are performed under rush, hazardous, or unusually difficult conditions that appropriately demand higher than normal labor wages (e.g., overtime or hazard pay) or time factors; or, where a remodeler performs work in a number of different cities, counties, or states having different tax rates. The Estimator Subprogram is further operable to automatically perform reverse or forward calculations to incorporate any such changes to a cost-affecting variable throughout the estimate or in individual records.

The Estimator Subprogram is preferably provided in the form of a master copy which is duplicated to create an estimate record for each estimate generated. This both advantageously preserves the integrity of the master copy and allows for maximum portability and availability because each estimate is able to stand independent of the master copy. Furthermore, the computer program is implemented such that the Estimator Subprogram and the estimate record copies thereof are operable to run entirely in RAM memory, thereby making program execution, particularly calculations, much faster than in the prior art. Thus, the independence and size of each estimate record allows for maximum portability and availability in the form of fast downloads over a network, such as the Internet, to a portable computing device, or the potential for storing and executing an estimate record on a portable hand-held device, such as a PDA.

The Materials Database is operable to store an editable list of the individual material and labor items as well as assemblies thereof, including unit prices and associated labor times. Thus, for example, costs and times for both installing individual sheets of sheetrock, repairing existing sheetrock, and finishing unit-areas of tile work may be included, as well as entire assemblies incorporating all material and labor costs and time factors for finishing a small bathroom. New assemblies may be created or existing assemblies may be edited as needed, which advantageously increases efficiency by allowing a user to select a single assembly of items rather than having to separately select each of the individual items comprising the assembly.

The Contract Subprogram is operable to import or otherwise receive any relevant information, including the estimate, from the Estimator Subprogram, and to receive any special terms or conditions related to performance of the project, and to combine both with editable contract language to generate a printable contract or other binding legal agreement. The advantageous ability to add special terms and conditions and the ability to modify the contract language allows the contract to be adapted to specific legal requirements of a particular state, county, or municipality as desired. Furthermore, the contract subprogram automatically calculates and enters a three day recission date allowed for by many jurisdiction. This calculation takes into account holidays and weekends. Additionally, the contract subprogram creates a schedule for draw payments and a final payment. Additionally, the contract subprogram automatically determines and selects an appropriate media size, and a number of pages in either letter or legal size, as desired.

The Production Subprogram is operable to import or otherwise receive any relevant information from the Estimator Subprogram, and to access the Worker, Subcontractor, and Vendor Databases to facilitate and coordinate assignment of workers, subcontractor work, and purchasing of materials and scheduling of deliveries, and to otherwise generate a project schedule. This includes, for example, importing the payment/draw schedule from the Contract Subprogram; importing the sequence of production phases and time required for each phase from the Estimator Subprogram; and importing or allowing entry of directions to the jobsite, special notes, and any special tools which might affect production. Additionally, the Production Subprogram is operable to import and incorporate digital photographs of the jobsite, whether in an undisturbed state or at various stages in the production process, as an aid to the production manager.

The Worker, Subcontractor, and Vendor Databases are operable to store and maintain editable lists of, respectively, workers, subcontractors, and vendors/suppliers, including contact information, and time factors and a budget for the workers and subcontractors. The production subprogram is operable to generate a vendor material list associating particular vendors with needed materials based on data entered into the Estimator Subprogram. In the vendor material list, the user can indicate whether the materials should be delivered to the shop, jobsite, or other destination.

It will be appreciated that other subprograms and databases, corresponding to any aspect of project estimating and management, such as, for example, obtaining appropriate permits, accepting bids, monitoring and applying for licenses, and monitoring and obtaining insurance, may be added as desired.

These and other important aspects of the present invention are more fully described in the section entitled DETAILED DESCRIPTION OF A PREFERRED EMBODIMENT, below.

### BRIEF DESCRIPTION OF THE DRAWING FIGURES

A preferred embodiment of the present invention is described in detail below with reference to the attached drawing figures, wherein:

FIG. 1 is plan view depiction of a preferred embodiment of a system of the present invention;

FIG. 2 is a block diagram showing interrelationships of a plurality of subprograms and databases of a preferred embodiment of a computer program of the present invention;

FIG. 3 is a flowchart showing steps in a preferred embodiment of a method of the present invention;

FIG. 4 is a screen capture of a preferred embodiment of an Estimator Interface screen generated by a computer program of the present invention; and

FIG. 5 is a screen capture of a preferred embodiment of an Assembly Interface screen generated by the computer program of the present invention.

### DETAILED DESCRIPTION OF THE PREFERRED EMBODIMENT

The present invention is a method and computer program for estimating project costs and time factors and facilitating project management, wherein the project concerns construction or remodeling or a similar endeavor, and the management thereof involves estimating material and labor costs; generating a contract, change order, or other legal agreement incorporating the estimate, any special terms or conditions, and standard contract language; and procuring the materials and necessary services, including subcontractor services, and scheduling deliveries and labor, including hourly workers. In a preferred embodiment, described herein, the method of project management is implemented using the computer program comprising a number of fully-integrated subprograms and databases advantageously operable to substantially eliminate a great deal of guesswork, with regard to both pricing and scheduling, heretofore associated with project management. This, in turn, results in greater reliability and efficiency and more consistent profits.

Referring to FIG. 1, a system 10 is shown operable to store or access and execute the computer program of the present invention. The system 10 may be any suitable conventional computing device having sufficient resources and ability to perform the functions described herein. As illustrated, the system 10 is a portable computing device, such as for example, a conventional laptop or notebook computer or a personal digital assistant (PDA), commonly available from a variety of well-known suppliers. Such portability advantageously allows the system 10 to be carried into work sites where facilitation of project management and access to information provided by the present invention is highly useful and desirable. Thus, for example, production schedules may be reviewed and updated or otherwise changed immediately on-site. Furthermore, in a preferred embodiment, the system 10 is operable to communicate with a main office or another site in order to relay and apprise other personnel of any changes. Alternatively, the system 10 may be embodied in a conventional non-portable or “desktop” personal computer.

Regardless of its form, however, the preferred system 10 broadly includes a first memory 12; a data communication connection 14; a second memory 16; a processor 18; a display 20; and one or more input devices 22,23. The first memory 12 is operable to store one or more of the subprograms and databases of the computer program, and may be alternatively embodied in, for example, a hard drive, a compact disk, a floppy disk, or any other similar conventional computer memory.

The data communication connection 14 is operable to allow the system 10 to transfer one or more of the subprograms and databases or copies thereof to or from a remote second computing device (not shown). The data communication connection 14 may be, for example, any wired or wireless network-type connection, including a local area network (LAN) connection, a wide area network (WAN) connection, or an Internet connection. The remote second computing device may be, for example, a conventional server computer, such as are commonly available from a variety of well-known suppliers.

It will be appreciated that, where practical, rather than storing the computer program locally in the first memory 12, the first memory 12 may be eliminated in favor of accessing the computer program stored on the remote second computing device via the data communication connection 14. Elimination of the first memory 12 may make the system 10 substantially smaller and lighter, thereby increasing the system's portability, which is particularly desirable where the system 10 is meant to be frequently carried into a field or work environment.

The second memory 16 is operable to store one or more portions of one or more of the subprograms and databases during execution thereof, and may be embodied in, for example, random access memory (RAM) or any other similar conventional computer memory.

The processor 18 is operable to execute the computer program. The display 20 is operable to communicate information generated by the processor 18 during execution of the computer program. The one or more input devices 22,23 are operable to allow a user to interact with the computer program. It will be appreciated that the natures of the processor 18, display 20, and input devices 22,23 will depend at least to some extent on the nature of the system 10, though all are preferably commonly available from a variety of well-known suppliers. For example, where the system 10 is designed to be extremely small and portable, such as a PDA, the processor 18 will likely be less powerful, the display 20 will likely be smaller, and the input device 22,23 will likely be a simple stylus or other pointing device.

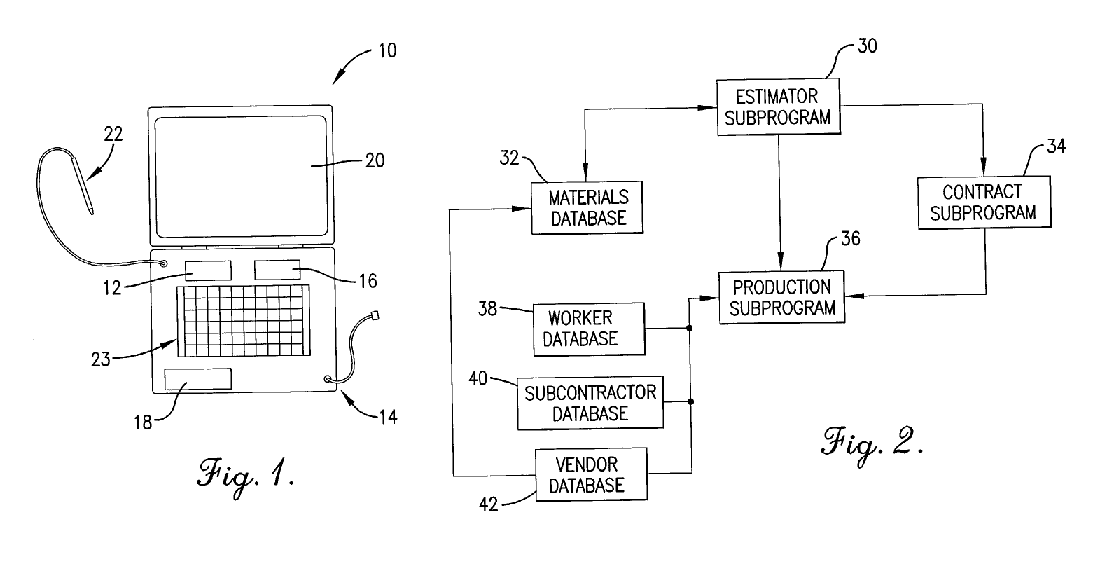

Referring also to FIG. 2, the computer program is preferably a cross-platform fully-integrated computer program comprising, as mentioned, a number of subprograms and databases, broadly including an Estimator Subprogram 30; a Materials Database 32; A Contract Subprogram 34; a Production Subprogram 36; a Worker Database 38; a Subcontractor Database 40; and a Vendor Database 42. The computer program is operable to be stored on the first or second memories 12,16 or accessed via the data communication connection 14 and executed by the processor 18. Though implementable in any conventional computer programming language, the program is preferably implemented in ProView Panorama, available from Proview Development Corporation. A computer listing appendix of source code operable to implement the present invention is submitted herewith and incorporated herein by reference. It will be appreciated that other substantially equivalent mechanisms may be devised for implementing the present invention, particularly with regard to minor changes in presentation or appearance, and such equivalents are considered to be within the scope of the present invention.

The Estimator Subprogram 30 is operable to access the Materials Database 32 to provide a spreadsheet-type list of material and labor items from which particular items necessary for completion of the project may be selected. Individual items may be selected or common assemblies comprising multiple items may be selected. Each item is associated with a unit cost and a time and labor cost. The result of such selections is a list of required items and a total cost estimate associated therewith.

The Estimator Subprogram 30 advantageously provides for maximum modifiability of desirably variable factors related to generating the estimate, such as, for example, unit cost, labor wage, gross profit margin (GPM), mark-up, and local taxes, time factors (in hours, minutes, and seconds, where appropriate), material prices, and unique job conditions, thereby making the present invention flexible and adaptable to varying project conditions and locales. The Estimator Subprogram 30 is further operable to automatically perform reverse or forward calculations to incorporate any such changes to a cost-affecting variable throughout the estimate.

Additionally, each individual record contains a “Cost Adjust Form” with up to ten item descriptions, including quantity and cost per unit (e.g., L.F., S.F., EA.). The cost per unit is imported from the updated Materials Database 32, described below. The total cost of each item in the Cost Adjust Form is calculated with appropriate sales tax and mark-up to a predetermined GPM to reflect sales price per unit in each of the aforementioned single records. The item, including the quantity and the adjusted total cost, is then automatically imported into a material list for the Production Subprogram 36 for ordering.

The Estimator Subprogram 30 is preferably provided in the form of a master copy which is duplicated to create an estimate record for each estimate generated. This both advantageously preserves the integrity of the master copy and allows for maximum portability and availability because each estimate is able to stand independent of the master copy. Furthermore, the computer program is implemented such that the Estimator Subprogram 30 and the estimate record copies thereof are operable to run entirely in RAM memory, thereby making program execution, particularly calculations, much faster than in the prior art. Thus, the independence and size of each estimate record allows for maximum portability and availability in the form of fast downloads over a network, such as the Internet, to a portable computing device, or the potential for storing and executing an estimate record on a portable hand-held device, such as a PDA.

The Materials Database 32 is operable to store an editable list of the individual material and labor items as well as assemblies thereof, including unit prices and labor times and cost factors. Thus, for example, costs and times for both installing individual sheets of sheetrock, repairing existing sheetrock, and finishing unit areas of tile work may be included, as well as entire assemblies incorporating all material and labor costs and times for finishing a small bathroom. New assemblies may be created or existing assemblies may be edited as needed, which advantageously increases efficiency by allowing a user to select a single common assembly of items rather than having to separately select each of the individual items comprising the assembly.

The Contract Subprogram 34 is operable to import or otherwise receive any relevant information, including the estimate, from the Estimator Subprogram 30, and to receive any special terms or conditions related to performance of the project, and to combine both with editable contract language to generate a printable contract, change order, or other binding legal agreement. The advantageous ability to add special terms and conditions and the ability to modify the contract language allows the contract to be adapted to specific legal requirements of a particular state, county, or municipality as desired. Furthermore, the contract subprogram automatically calculates and enters a three day recission date allowed for by many jurisdiction. This calculation takes into account holidays and weekends. Additionally, the Contract Subprogram 34 creates a schedule for draw payments and a final payment. Additionally, the Contract Subprogram 34 automatically determines and selects an appropriate media size, and a number of pages in either letter or legal size, as desired.

The Production Subprogram 36 is operable to import or otherwise receive any relevant information from the Estimator Subprogram 30, including selected materials and associated labor times, and to access the Worker, Subcontractor, and Vendor Databases 38,40,42 to facilitate and coordinate assignment of workers, subcontractor work, and purchasing of materials and scheduling of deliveries, and to otherwise generate a project schedule. This includes, for example, importing the payment/draw schedule from the Contract Subprogram 34; importing the sequence of production phases and time required for each phase from the Estimator Subprogram 30; and importing or allowing entry of directions to the jobsite, special notes, and any special tools which might affect production. Additionally, the Production Subprogram 36 is operable to import and incorporate digital photographs of the jobsite, whether in an undisturbed state or at various stages in the production process, as an aid to the production manager.

The Production Subprogram 36 is further operable to remind of situations actually or potentially requiring special consideration, such, as for example, yard signs, required permits, lock boxes, or special tools needed for the project. Though seemingly of lesser importance, these issues, when overlooked, can hold up work and greatly decrease efficiency and profits margin.

The Worker, Subcontractor, and Vendor Databases 38,40,42 provide editable lists of workers, subcontractors, and vendors/suppliers, respectively. The worker and subcontractor lists include both contact and availability information; the vendor/supplier list includes contact and product information. As is described in greater detail below, the present invention allows for both manual and automatic assignment or association of workers, subcontractors, and vendor/suppliers during generation of the production schedule. Furthermore, the Production Subprogram 36 is operable to generate a vendor material list associating particular vendors with needed materials based on data entered into the Estimator Subprogram 30. In the vendor material list, the user can indicate whether the materials should be delivered to the shop, jobsite, or other destination.

It will be appreciated that other subprograms and databases, corresponding to any aspect of project management, such as, for example, obtaining appropriate permits, accepting bids, monitoring and applying for licenses, and monitoring and obtaining insurance, may be added as desired.

In use and operation, referring to FIG. 3, the method of the present invention broadly comprises the processes of generating an estimate, as depicted in box 50; generating a contract based at least partly upon data taken from the estimate, as depicted in box 52; and generating a production schedule, again, based at least partly upon data taken from the estimate, as depicted in box 54.

The process of generating an estimate begins with receiving client information, including a name or other identifier and contact information, as depicted in box 56. This step is not necessary, however, as a default or temporary identifier, such as, for example, the time and date of creation, may be used to identify the estimate record, which is useful when the client is merely seeking a quick estimate and does not wish to provide detailed contact information. The client information may be entered later if the client decides to proceed with the project.

The master copy of the Estimate Subprogram 30 is then copied to create the current estimate record, as depicted in box 58. This step, though preferred, is not necessary either; the advantages of this implementation, however, are set forth above.

The user may then select material and labor items involved in the project. In a preferred embodiment, these items are divided into categories and subcategories to make identification easier. Thus, the user selects a category, as depicted in box 60; selects a subcategory, as depicted in box 62; and then selects material and labor items, as depicted in box 64. These steps are repeated until all material and labor items required by the project have been selected, as depicted in decision box 66.

The user may then consolidate the estimate record and eliminate all unselected items, as depicted in box 68. This makes the estimate easier to read and conserves computer memory and processing resources.

The user may then make adjustments to the various fields associated with the selected items, including adjusting unit price, labor wage, gross profit margin, and mark-up, as depicted in box 70.

Lastly, the user may calculate a total cost and work-hours required to complete the project, as well as a financing strategy, as depicted in box 72. The present invention does not require that financing be furnished, but does include the ability to conveniently provide the client with financing information, including monthly payments for a given interest rate and payment term.

The process of generating the contract begins with identifying the estimate record for which a contract is desired, as depicted in box 76. The desired estimate record may selected from a scrollable drop down menu of existing estimate records. The Contract Subprogram 34 then imports all relevant data from the selected estimate record, including client information and total cost, as depicted in box 78.

Additional contract-specific client information may be entered, as depicted in box 80. This feature recognizes that the client may reside or desire contract-related communication to be directed to an address or telephone number different from that provided for the estimate record.

It will be appreciated that in the remodeling and construction industry, rather than providing full payment up-front, it is common to provide for periodic draws of cash. An additional draw may be made, for example, when the prior draw is depleted or when a new project stage is reached. The number of draws and draw amounts may be entered into the contract, as depicted in box 82. Note, however, that, as desired, information related to the draws need not be made part of the contract.

The user may then enter any special terms or conditions, such as, for example, deadlines or an indemnity clause, for incorporation into the final contract, as depicted in box 84. The special terms may also include special legal requirements specific to the work site or locale.

Lastly, the client information, any additional contract-specific client information, number and amount of any draws, and special terms and conditions are automatically combined with standard contract language to result in the final contract, as depicted in box 86. The standard contract language is widely available in, among other things, generic, preprinted forms, and may be tailored to the user's particular needs and desires.

The process of generating a production schedule begins with identifying the estimate record for which a production schedule is desired, as depicted in box 90. The desired estimate record selected from a scrollable drop-down menu of existing estimate records. The Production Subprogram 36 then imports all relevant data from the selected estimate record, including client information and total cost, as depicted in box 92.

Workers and subcontractors are assigned and scheduled based upon the selected material and labor items in the estimate record, as depicted in box 94. Vendors are selected and contacted, again based upon the items selected in the estimate record, as depicted in box 96. The Production Subprogram 56 is advantageously operable to automatically generate order forms and fax coversheets, as depicted in box 98, based upon vender contact information provided by the Vendor Database 42.

A schedule of events may then be generated, as depicted in box 100, wherein the steps in completing the project are set forth in logic order. Worker assignments, subcontractor work, and deliveries of materials are also included in the schedule. The schedule may be printed and distributed as needed, or, as mentioned above, may be taken to or accessed from a worksite or other remote location.

As mentioned, performance of the above-described method is facilitated by the computer program of the present invention. Upon execution of the computer program, a master interface screen appears presenting graphical buttons or icons selectable to initiate a number of major functions, including a MASTER COPY button; a NEW CLIENT button; an OLD CLIENT button; a QUICK BID button; a CONTRACT button; and a PRODUCTION button. Selecting the MASTER COPY button allows access to the master copy of the Estimator Subprogram 30 wherein general changes may be made to data and other content contained therein. As mentioned, an estimate record copy of the Estimator Subprogram 50 master copy is created each time a new estimate is initiated, thereby ensuring continued integrity of the master copy. Nevertheless, it may often be desirable to make changes to the master copy itself, such as when changing a default value applicable to all future estimates.

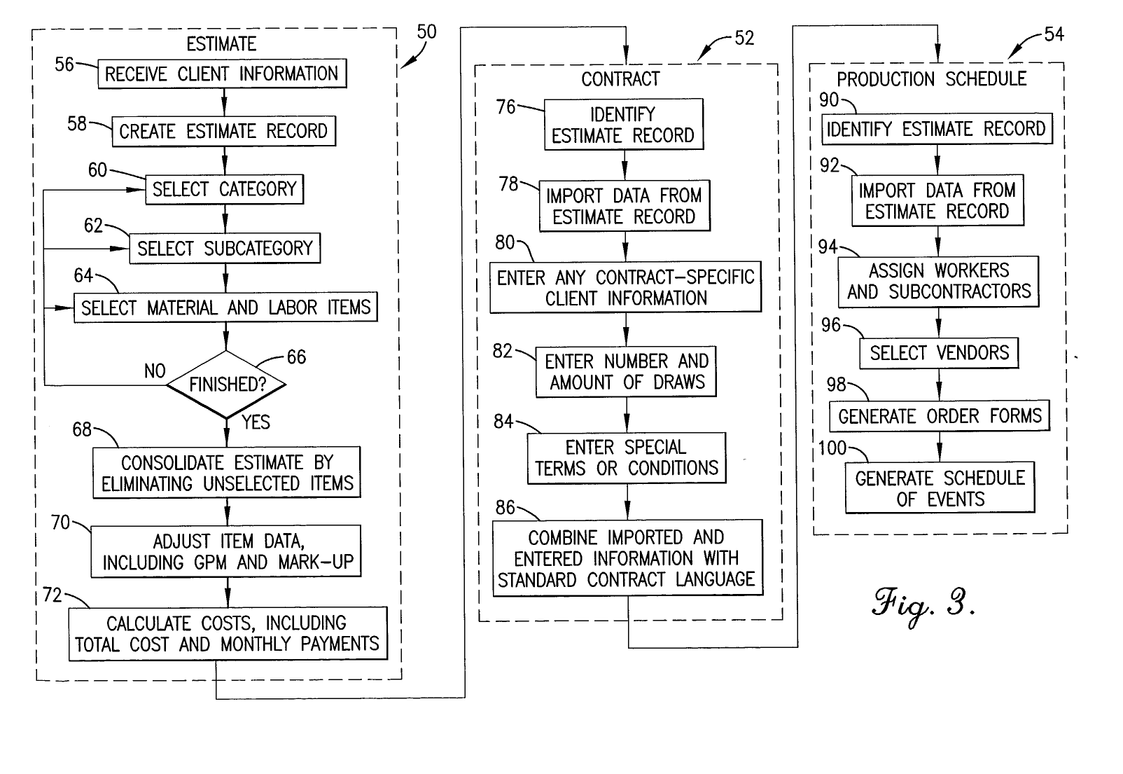

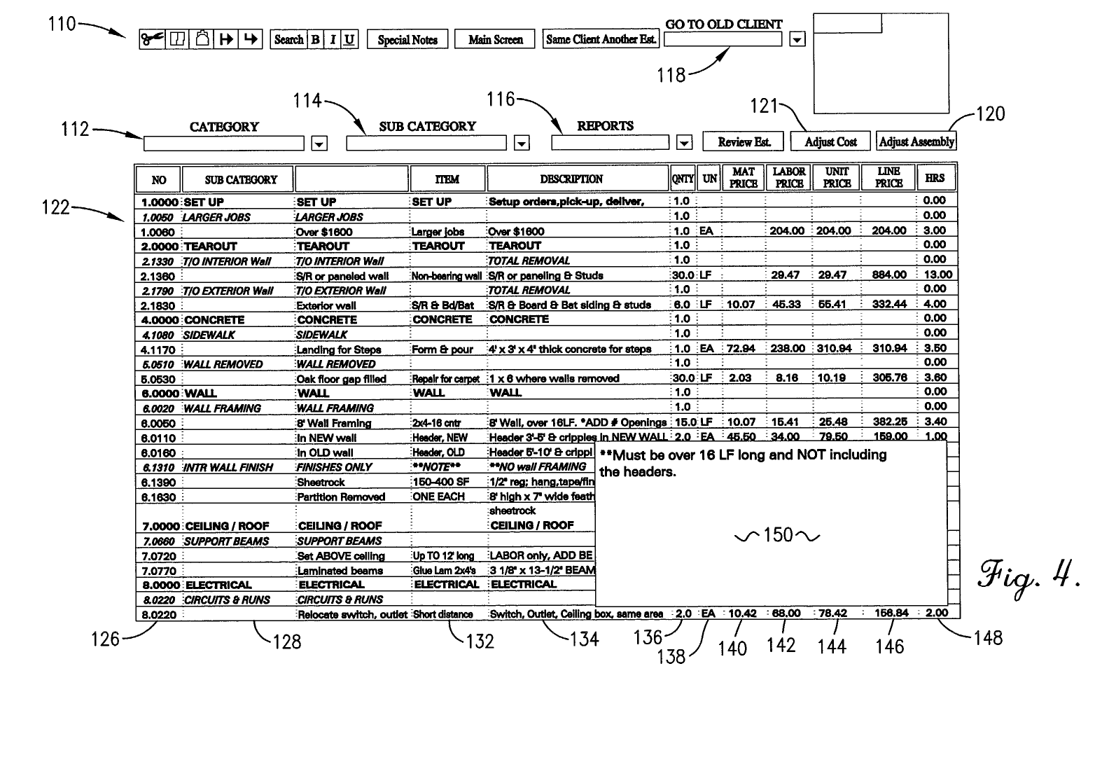

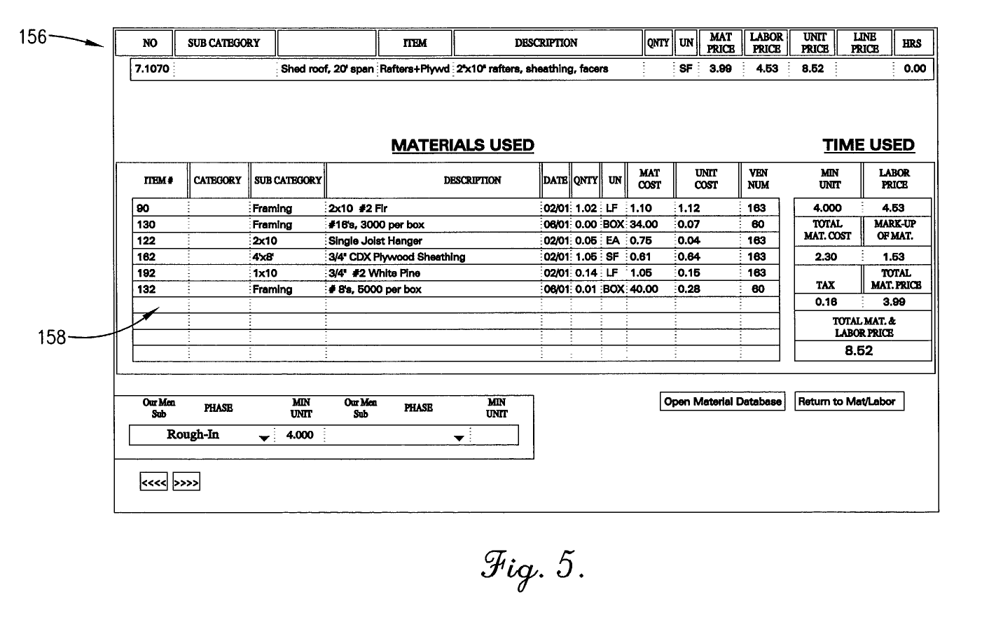

Selecting the NEW CLIENT, OLD CLIENT, or QUICK BID buttons allows access via an estimator interface screen 110 (see FIG. 4), described below, to a selected estimate record created for and reflecting data related to a particular client and project. Selecting the NEW CLIENT button causes to appear a client information window wherein may be entered a client's identifier or name, address, and telephone number. The client information window may also provide a data field wherein may be entered a broad characterization of the project, such as, for example, “bathroom”, “new fence”, “paint house exterior”, “deck”, “two tier deck”, or “fireplace”. Populating these data fields and selecting an OK button initiates duplication of the master copy to create the estimate record and associate it with the client's name or other identifier as entered in the client information window.

Selecting the OLD CLIENT button causes a scrollable drop-down menu of selectable, previously-created estimate records to appear. Selecting an estimate record and an OPEN button causes the estimate record to open.

Selecting the QUICK BID button opens a new estimate record and operates substantially similar to the NEW CLIENT function, but bypasses the client information window. A default filename is assigned to the newly created estimate record based upon the time and date of initiation. This feature is particularly advantageous where a customer desires a quick or rough estimate or is not otherwise able or desirous at the time to provide client information data. Instead, an estimate record may be opened and an estimate generated, and the record then deleted or, at some convenient time thereafter, provided with client information data.

Referring also to FIG. 4, the Estimator Subprogram 30 and the identical estimate record copies thereof present the estimate interface screen 110 comprising a CATEGORY drop down menu 112, a SUBCATEGORY drop down menu 114; a GO TO OLD CLIENT drop down menu 118; an ADJUST ASSEMBLY button 120; a spreadsheet of selectable materials and labor items 122; a REPORTS drop down menu 123; and an ADJUST COST button 124. The CATEGORY drop down menu 112 presents a scrollable list of selectable task categories, including, for example, SETUP; TEAROUT; EXCAVATION; CONCRETE; FLOOR; WALL; CEILING/ROOF; ELECTRIC; PLUMBING; HEAT/COOL/VENTILATORS; DOORS/WINDOWS; INSULATION; MILLWORK/STAIRS; CABINETS; PORCH/DECK; SUNROOM; PAINT/STAINING; and CLEANUP. Selecting one of these task categories affects both the SUBCATEGORY drop down menu 114 and spreadsheet of selectable items 122, as described below.

The SUBCATEGORY drop down menu 114 presents a scrollable list of selectable subtask categories. The particular subtask categories presented are specific to the task category selected from the CATEGORY drop down menu 112. Thus, for example, if the WALL task category is selected, then the subtask categories might include WALL FRAMING; WALL BLOCKING; GRAB-BARS; EXTERIOR SIDING; SIDING REPAIRS; STUCCO REPAIRS; ALUMINUM WRAP; INTERIOR WALL FINISHING; BATHTUB WALLS; SHOWER WALLS; CERAMIC TILE; WALLPAPER; and WOOD PANELING, each of which contains one or more additional records.

The GO TO OLD CLIENT drop down menu 118 presents a scrollable drop down menu of selectable existing estimate records. The GO TO OLD CLIENT drop down menu 118 is substantially identical to the drop down menu which appears when the OLD CLIENT button is selected from the master interface screen, as described above.

Referring also to FIG. 5, the ADJUST ASSEMBLY button 120 is operable when selected to cause to be displayed an assembly component interface screen 156, wherein common assemblies comprising a plurality of items may be created and edited to occupy only a single selectable entry in the spreadsheet 122. As illustrated, for example, construction of a shed roof involves an assembly or list of numerous items 158. This feature advantageously allows the user to create and select common assemblies, rather than having to separately select every component of the assembly each time the assembly is called for.

Referring back to FIG. 4, the spreadsheet of selectable items 122 occupies a portion of the estimator interface screen 110 and presents, in spreadsheet form, selectable materials and labor items associated with a task selected from the CATEGORY drop down menu 112 or a subtask selected from the SUBCATEGORY drop down menu 114. Each item occupies one or more rows of the spreadsheet. Each row is divided into a number of data columns, including a NO. column 126; a CATEGORY/SUBCATEGORY column 128; an ITEM column 132; a NOTE column 134; a DESCRIPTION column 136; a QNTY column 138; a UNIT column 140; a MAT PRICE column 142; a LABOR PRICE column 144; a UNIT PRICE column 146; a LINE PRICE column 148; and an HOURS column 150.

The NO. column 126 contains a two-part number operable to locate the material or labor item in the Materials Database 32. The first and second parts of the two-part number indicate, respectively, which category or subcategory the item belongs to and where the item is located relative to other items in that category or subcategory. The CATEGORY/SUBCATEGORY column 128 contains a text identifier indicating which category or subcategory or subcategory the material or labor item belongs to. The ITEM column 132 contains a text description of the material or labor item. The DESCRIPTION column 134 may a brief general or project-specific note related to the material or labor item. The QNTY column 136 indicates a needed number or quantity of the item. The UNIT column 138 is associated with the QNTY column 136 and indicates a unit of measure describing the nature of the needed quantity, such as, for example, “EA” for each or “LF” for lumber-foot. The MAT PRICE column 140 indicates the material price per base unit of the material component of the item. The LABOR PRICE column 142 indicates the labor price per base unit (hour) of any labor associated with, for example, installing the item. The UNIT PRICE column 144 contains a unit dollar amount equal to the sum of the material price per base unit (from the MAT PRICE column 140) and the labor price per base unit (from the LABOR PRICE column 142). The LINE PRICE column 146 contains a total dollar amount equal to the item quantity (from the QNTY column 136) multiplied by the unit dollar amount (from the UNIT PRICE column 144). The HRS column 148 contains a labor time total equal to the estimated number of labor hours required to complete the labor component of the item.

It will be apparent that the information in some of the columns, particularly, for example, the UNIT PRICE and LINE PRICE columns 144,146 is a function of information provided in other columns. An advantageous feature of the present invention involves automatic forward and reverse calculations. Thus, for example, if the quantity, material price, or labor price associated with an item is changed, this change will be automatically and immediately reflected in the UNIT PRICE and LINE PRICE columns 144,146.

Selecting any cell of the spreadsheet 122 will cause to appear a dialogue box 150 presenting editable notes or a general description of the contents of the cell.

When the user has finished selecting items, the estimate record may be consolidated to eliminate unselected items so that only the selected items remain displayed in the spreadsheet 122. This feature advantageously allows the user to focus only on the selected items for better and more efficient understanding, and also conserves memory, processing, and other computer resources.

The REPORTS drop down menu 123 presents a list of selectable report categories, including, for example, CATEGORY TOTAL PRICES; PROJECT TOTAL PRICE; LINE ITEM PRICES; PHASE CATEGORY TOTAL PRICES; and LABOR HOURS SPREADSHEET. These reports are summaries of information, particularly costs and labor hours, that may be extracted from the estimate. Once all required items have been selected and, as appropriate, edited, these summarizing reports may be displayed or printed. It will be appreciated that different versions of the reports may be created, with each version possibly having different degrees of detail tailored to a particular audience. A client version of the report, for example, might eliminate MAT PRICE or LABOR PRICE and include only total UNIT PRICE.

The ADJUST COST button 124 is operable when selected to open an interface window allowing the user to adjust gross profit margin or mark-up. The window is divided into a materials section and a labor section. The materials section provides data entry fields for specifying and editing gross profit margin and mark-up. The labor section provides data entry fields for gross profit margin, mark-up, and labor wage (hourly pay rate). The data entry fields are appropriately linked so as to allow for automatic and immediate forward and reverse calculations. Thus, for example, an increase in mark-up for materials will be reflected in a corresponding increase in unit prices for all materials. This feature advantageously allows the user to adjust mark-up and gross profit margin to reflect any number of conditions making such adjustment appropriate, including, for example, a rush schedule, hazardous or otherwise difficult work environment or conditions, and local peculiarities in material or labor costs.

Selecting the CONTRACT button from the main interface screen causes to be executed the Contract Subprogram 34 whereby a contractual agreement is created based upon a completed estimate record. Though such contracts are well-known in the art, the present invention advantageously integrates creation of the contract with the underlying estimate, thereby increasing accuracy and efficiency.

Execution of the Contract Subprogram 34 causes to appear a contract interface screen allowing the user to select an OLD CONTRACT button; a DELETE CONTRACT button; or a CREATE NEW CONTRACT. Selecting the OLD CONTRACT button causes to be displayed a scrollable drop-down menu of selectable existing client contracts.

Selecting the DELETE CONTRACT button causes to be displayed a window presenting a scrollable drop-down menu of existing client contracts, a DELETE button, and a CLOSE button. Selecting an existing client contract from the menu highlights that particular existing client contract; selecting the DELETE button causes the highlighted existing client contract to be deleted; selecting the CLOSE button causes the window to be closed.

Selecting the NEW CONTRACT button causes to be displayed a series of interface screens, the first being for associating the newly created contract with an existing estimate. In order to facilitate such association, a scrollable drop-down menu is provided wherefrom an existing estimate may be selected. The first interface screen also presents a number of data fields containing the client information associated with the selected estimate. The displayed client information may be changed for purposes of contract creation without changing the client information associated with the underlying estimate. This is particularly advantageous where, for example, the estimate or jobsite address is different from the contract or billing address. This first user interface screen is the first screen in a number of sequential screens corresponding to steps in the contract creation process.

NEXT or BACK buttons or icons at the bottom of each interface screen allow the user to navigate among the sequential interface screens. From the first interface screen, selecting the NEXT button causes to be displayed a second interface screen presenting a number of editable data fields, including a CONTRACT TOTAL field; a DOWN PAYMENT field; a DRAW field; and a FINAL field. The CONTRACT TOTAL field presents a total cost determined in and taken from the client estimate. The DOWN PAYMENT field communicates the amount of down payment money provided by the client. The DRAW field communicates total money draws determined as a number of draws multiplied by a money value for each draw. The FINAL field provides the total amount due after subtracting the down payment and total draw amounts from the contract total.

From the second interface screen, selecting the NEXT button causes to be displayed a third interface screen presenting a large data entry box within which any specific terms or conditions of the contract, such as, for example, deadlines or an indemnity clause, may be entered. In a preferred embodiment, only specifics of the contract are entered, these being integrated with standard contract language provided by the program to produce the final contract.

From the third interface screen, selecting NEXT causes to be displayed a fourth interface screen presenting a NUMBER OF COPIES data field allowing the user to specify the number of contract copies desired to be printed. This number will typically be at least two, including one copy for the client and one copy for the user or sales agent. The fourth interface screen also present a PRINT button or icon operable when selected to cause to be printed the number of copies of the contract specified in the NUMBER OF COPIES data field.

Information provided under both the Estimator and Contract Subprograms 30,34 is integrated along with standard language to result in the final contract form. This standard language is changeable to accommodate variances in local state laws and local ordinances as well as the user's particular needs and desires. Thus, for example, the client information provided initially in the Estimator Subprogram 30 and carried over to the Contract Subprogram 34 may be integrated into the contract form unless contract-specific client information has been provided. It will be appreciated that standard contracts and contract language are readily available and are easily adapted and converted, with the proper permissions, into electronic form for use by the Contract Subprogram 34.

Selecting the PRODUCTION button from the main interface screen causes to be executed the Production Subprogram 36 whereby work assignments are made, materials are ordered, and work and deliveries are scheduled. Though such scheduling is well-known in the art, the present invention advantageously integrates creation of the production schedule with the underlying estimate, thereby increasing accuracy and efficiency. In support of the Production Subprogram are the Worker, Subcontractor, and Vendor Databases 38,40,42.

Execution of the Production Subprogram 36 causes to appear a sequence of interface screens. The first two interface screens generated by the Production Subprogram 36 are for calling-up a particular client estimate may be substantially similar if not identical to those described above as being generated by the Contract Subprogram 34.

A third production interface screen presents information relating to costs and payments, and particularly includes a # OF DRAWS data field and a DRAW AMOUNT data field, both of which are of concern to production. The concept of a “draw” was explained above. Thus, # OF DRAWS indicates the number of periodic installment payments, and DRAW AMOUNT indicates the amount of each such payment. This information may be imported from the Contract Subprogram 34 where it was first entered.

Selecting NEXT causes to appear a fourth production interface screen presenting a TOTAL JOB HRS. data field; a TOTAL CARP. HRS data field; a LEADMAN REQUESTED data field; a LEADMAN TOTAL MAN HRS. data field; a START DAY data field; a plurality of HELPER TOTAL MAN HRS. data fields; and a plurality of HELPER START DAY data fields. The TOTAL JOB HRS. data field is the sum total of worker and subcontractor hours, and is filled by information taken from the Estimator Subprogram 30. The TOTAL CARP. HRS data field is the worker hours component of the total work hours, and is filled by information taken from the Estimator Subprogram. The LEADMAN REQUESTED data field is the name of the worker as leadman chosen from a scrollable drop down list of workers linked to the Worker Database 38. The LEADMAN TOTAL MAN HRS. data field and the START DAY data field are, respectively, the leadman hours component of the total worker hours and the project day on which these hours begin. The plurality of HELPER TOTAL MAN HRS. data fields and the plurality of HELPER START DAY data fields are, respectively, for each helper to the leadman, the helper hour component of the total worker hours and the project day on which these hours begin. The sum total of leadman hours and helper hours should equal the total worker hours.

Selecting NEXT causes to appear a fifth production interface screen presenting a number of checkable special items boxes, includes a LOCK BOX NEEDED box; a YARD SIGN NEEDED box; and a PERMIT NEEDED box. A checked box indicates that the item associated with that box is needed.

Selecting NEXT causes to appear a sixth production interface screen presenting subcontractor information in a spreadsheet-type format, wherein all or part the information is imported from the Estimator Subprogram 30 and the Subcontractor Database 40. The spreadsheet preferably includes a SPECIAL NOTES column, wherein special notes related to a particular subcontractor's needs for the particular task or project may be entered. This feature advantageously allows for notice of these special needs, thereby potentially improving efficiency and making the subcontractor's job easier.

Selecting NEXT causes to appear a seventh production interface screen presenting vendor information in a spreadsheet-type format, wherein all or part of such information is imported from the Estimator Subprogram 30 and the Vendor Database. The spreadsheet preferably includes a WILL CALL/JOB/SHOP column, wherein an indication may be made as to where the vendor's product will be made available.

Selecting NEXT causes to appear an eighth production interface screen presenting a sequence of events list comprising a plurality of editable data fields wherein high-level steps or phases in completing the project may be set forth.

Selecting NEXT causes to appear a ninth production interface screen presenting a DIRECTIONS box, which is editable to set forth directions to the project site, and a SPECIAL NOTES box, which is editable to set forth general instructions applicable to the project and project site.

Selecting NEXT causes to appear a tenth production interface screen presenting a LIST OF SPECIAL TOOLS box comprising a list of data fields editable to set forth any special tools required to complete the project. This feature advantageously allows the user to identify and post any required special tools, thereby potentially improving efficiency by avoiding work-day waiting for the special tools to be retrieved or delivered.

Selecting NEXT causes to appear an eleventh production interface screen presenting a MATERIAL LIST spreadsheet of materials associated with a particular vendor designated in a vendor address and contact box. A DELIVERY LOCATION box indicates where the materials will be made available. This feature advantageously provides a checklist of materials as well as vendor contact information, thereby potentially making more efficient and reliable the procurement of the materials.

The Production Subprogram 36 is also operable to generate an order form based upon the vendor information from the Vendor Database 38 and the materials needed and known to be available from a particular vendor. The order form may be generated in a fax-coversheet configuration having a conventional fax cover sheet portion followed by a material list in spreadsheet form. The material list of the order form is substantially similar or identical to the MATERIAL LIST spreadsheet presented in the eleventh production interface screen. As mentioned, the provision of a check list corresponding to the order form potentially improves efficiency and reliability of material procurement.

The Production Subprogram 36 is operable to generate a production sheet setting forth some or all of the production information discussed in the preceding paragraphs. Specifically, in the upper right hand corner is a CLIENT INFORMATION section; in the upper left hand corner is a SPECIAL NEEDS section and a COST and PAYMENT section. Other sections include a SEQUENCE OF EVENTS section; a WORKERS SCHEDULED section; a SUBCONTRACTORS section; a VENDORS section; a DIRECTIONS section; a COMMENTS section; and a LIST OF SPECIAL TOOLS section. The contents of these sections is self-explanatory and corresponds to information received or generated, as described above, by the various subprograms and databases.

From the preceding description, it will be appreciated that the present invention, a method and computer program for facilitating project management, wherein the project concerns remodeling or construction or a similar endeavor, provides a distinct advance in the art of project management tools.

Although the invention has been described with reference to the preferred embodiment illustrated in the attached drawings, it is noted that equivalents may be employed and substitutions made herein without departing from the scope of the invention as recited in the claims. For example, though a preferred embodiment of the computer program has been described in detail, many of these details, particularly with regard to presentation and appearance, may be changed without departing from the contemplated scope of the present invention.

Having thus described the preferred embodiment of the invention, what is claimed as new and desired to be protected by Letters Patent includes the following:

1. A method of managing a project, the method comprising the steps of:
(a) allowing for selection of an item from a list of items, wherein the list of items includes a plurality of materials required to complete the project, with each of the plurality of materials being associated with a material cost, a labor time, and a total item cost;
(b) generating an estimate of a total project cost for completing the project based at least in part upon a summation of the total item costs;
(c) allowing for entry of a special contract term; and
(d) incorporating automatically the estimate and the special contract term into an editable contract of otherwise standard contract language.

2. The method as set forth in claim 1, further comprising the step of allowing for the entry of client information sufficient to identify a particular client, and of associating the client information with the project.

3. The method as set forth in claim 1, wherein the list of items is based upon an underlying editable database of items.

4. The method as set forth in claim 1, wherein the list of items includes an assembly representing a plurality of items.

5. The method as set forth in claim 1, further comprising the steps of
(e) allowing for editing the material cost and the labor time;
(f) allowing for editing a gross profit margin which will directly affect the total item cost;
(g) allowing for editing a tax rate which will directly affect the total item cost; and
(h) performing automatically reverse and forward calculations to incorporate into the total item cost any editing of the material cost and the labor time, the gross profit margin, and the tax rate.

6. The method as set forth in claim 1, further comprising the step of (e) generating a financing strategy based upon the total project cost and providing the financing strategy with the estimate.

7. The method as set forth in claim 1, further comprising the step of (e) allowing for specifying a number of draws and an amount of each draw, and incorporating the number of draws and the amount of each draw into the contract.

8. A method of managing a project, the method comprising the steps of:
(a) allowing for selection of an item from a list of items, wherein the list of items includes a plurality of materials required to complete the project, with each of the plurality of materials being associated with a material cost, a labor time, and a total item cost;
(b) generating an estimate of a total project cost for completing the project based at least in part upon a summation of the total item costs;
(c) allowing for specifying a number of draws and an amount of each draw;
(d) allowing for an editable worker database wherefrom a worker may be selected and assigned to the project;
(e) allowing for an editable subcontractor database wherefrom a subcontractor may be identified and selected for the project;
(f) allowing for an editable vendor database wherefrom a vendor may be selected for supplying the item selected from the list of items;
(g) generating, based upon information in the editable vendor database, an order form addressed to a specific vendor and ordering the item;
(h) allowing for identification of any special considerations related to completing the project, including any special tools required to complete the project.
(i) incorporating automatically the client information, the estimate, the number of draws, the amount of each draw, the worker, the subcontractor, the vendor, and the special considerations into a schedule for completing the project.

9. The method as set forth in claim 8, further comprising the step of allowing for the provision of client information sufficient to identify a particular client, and of associating the client information with the project.

10. The method as set forth in claim 8, wherein the list of items is based upon an editable database of items.

11. The method as set forth in claim 8, wherein the list of items includes an assembly representing a plurality of items.

12. The method as set forth in claim 8, further comprising the steps of
(j) allowing for editing the material cost and the labor time;
(k) allowing for editing a gross profit margin which will directly affect the total item cost;
(l) allowing for editing a tax rate which will directly affect the total item cost; and
(m) performing automatically reverse and forward calculations to incorporate into the total item cost any editing of the material cost and the labor time, the gross profit margin, and the tax rate.

13. The method as set forth in claim 8, further comprising the step of (j) generating a financing strategy based upon the total project cost and providing the financing strategy with the estimate.

14. The method as set forth in claim 8, further comprising the step of (j) allowing for specifying a number of draws and an amount of each draw, and incorporating the number of draws and the amount of each draw into the schedule.

15. A method of managing a project, the method comprising the steps of:
(a) receiving client information, including a client identifier, and associating the client information with the project;
(b) allowing for selection of an item from a list of items, wherein the list of items includes a plurality of materials required to complete the project, with each of the plurality of materials being associated with a material cost, a labor time, and a total item cost;
(c) allowing for editing the material cost and the labor time;
(d) allowing for editing a gross profit margin which will directly affect the total item cost;
(e) allowing for editing a tax rate which will directly affect the total item cost;
(f) performing automatically reverse and forward calculations to incorporate into the total item cost any editing of the material cost and the labor time, the gross profit margin, and the tax rate;
(g) generating an estimate of a total project cost for completing the project based at least in part upon a summation of the total item costs;
(h) generating a financing strategy based upon the total project cost;
(i) allowing for specifying a number of draws and an amount of each draw;
(j) allowing for entry of a special contract term;
(k) incorporating automatically the client information, the estimate, the financing strategy, the number of draws, the amount of each draw, and the special contract term into a contract;
(l) allowing for an editable worker database wherefrom a worker may be selected and assigned to the project;
(m) allowing for an editable subcontractor database wherefrom a subcontractor may be identified and selected for the project;
(n) allowing for an editable vendor database wherefrom a vendor may be selected for supplying the item selected from the list of items;
(o) generating, based upon information in the editable vendor database, an order form addressed to a specific vendor and ordering the item;
(p) allowing for identification of any special considerations related to completing the project, including any special tools required to complete the project.
(q) incorporating automatically the client information, the estimate, the number of draws, the amount of each draw, the worker, the subcontractor, the vendor, and the special considerations into a schedule for completing the project.

16. A computer program for facilitating management of a project, the computer program being stored on a computer-readable medium and executable by a computing device, the computer program comprising:
a code segment allowing for selection of an item from a list of items, wherein the list of items includes a plurality of materials required to complete the project, and each of the plurality of materials is associated with a material cost, a labor time, and a total item cost;
a code segment for generating an estimate of a total project cost for completing the project based at least in part upon a summation of the total item costs;
a code segment allowing for entry of a special contract term; and
a code segment for incorporating automatically the client information, the estimate, and the special contract term into an editable contract of otherwise standard contract language.

17. The computer program as set forth in claim 16, further comprising a code segment allowing for provision of client information sufficient to identify a particular client, and for associating the client information with the project.

18. The computer program as set forth in claim 16, wherein the list of items is based upon an editable database of items.

19. The computer program as set forth in claim 16, further comprising
a code segment allowing for editing of the material cost and the labor time;
a code segment allowing for editing a gross profit margin which will directly affect the total item cost;
a code segment allowing for editing a tax rate which will directly affect the total item cost; and
a code segment for performing automatically reverse and forward calculations to incorporate into the total item cost any editing of the material cost and the labor time, the gross profit margin, and the tax rate.

20. The computer program as set forth in claim 16, further comprising a code segment for generating a financing strategy based upon the total project cost and providing the financing strategy with the estimate.

21. The computer program as set forth in claim 16, further comprising a code segment allowing for specifying a number of draws and an amount of each draw, and incorporating the number of draws and the amount of each draw into the contract.

22. A computer program for facilitating management of a project, the computer program being stored in a computer-readable medium and executable by a computing device, the computer program comprising:
a code segment allowing for selection of an item from a list of items, wherein the list of items includes a plurality of materials required to complete the project, and each of the plurality of materials is associated with a material cost, a labor time, and a total item cost;
a code segment for generating an estimate of a total project cost for completing the project based at least in part upon a summation of the total item costs;
a code segment allowing for specifying a number of draws and an amount of each draw;
an editable worker database wherefrom a worker may be selected and assigned to the project;
an editable subcontractor database wherefrom a subcontractor may be identified and selected for the project;
an editable vendor database wherefrom a vendor may be selected for supplying the item selected from the list of items;
a code segment for generating, based upon information in the editable vendor database, an order form addressed to a specific vendor and ordering the item;
a code segment allowing for identification of any special considerations related to completing the project, including any special tools required to complete the project;
a code segment for incorporating automatically the client information, the estimate, the number of draws, the amount of each draw, the worker, the subcontractor, the vendor, and the special considerations into a schedule for completing the project.

23. The computer program as set forth in claim 22, further comprising a code segment allowing for entry of client information sufficient to identify a particular client, and of associating the client information with the project.

24. The computer program as set forth in claim 22, wherein the list of items is based upon an editable database of items.

25. The computer program as set forth in claim 22, further comprising
a code segment allowing for editing of the material cost and the labor time;
a code segment allowing for editing a gross profit margin which will directly affect the total item cost;
a code segment allowing for editing a tax rate which will directly affect the total item cost; and
a code segment for performing automatically reverse and forward calculations to incorporate into the total item cost any editing of the material cost and the labor time, the gross profit margin, and the tax rate.

26. The method as set forth in claim 22, further comprising a code segment for generating a financing strategy based upon the total project cost and providing the financing strategy with the estimate.

27. The computer program as set forth in claim 22, further comprising a code segment allowing for specifying a number of draws and an amount of each draw, and incorporating the number of draws and the amount of each draw into the schedule.

28. A computer program for facilitating management of a project, the computer program being stored in a computer-readable medium and executable by a computing device, the computer program comprising:
a code segment for receiving client information, including a client identifier, and associating the client information with the project;
a code segment allowing for selection of an item from a list of items, wherein the list of items include a plurality of materials required to complete the project, and each of the plurality of materials is associated with a material cost, a labor time, and a total item cost;
a code segment allowing for editing of the material cost and the labor time;
a code segment allowing for editing a gross profit margin which will directly affect the total item cost;
a code segment allowing for editing a tax rate which will directly affect the total item cost;
a code segment for performing reverse and forward calculations to incorporate into the total item cost any editing of the material cost and the labor time, the gross profit margin, and the tax rate;
a code segment for generating an estimate of a total project cost for completing the project based at least in part upon a summation of the total item costs;
a code segment for generating a financing strategy based upon the total project cost;
a code segment allowing for specifying a number of draws and an amount of each draw;
a code segment allowing for entry of a special contract term;
a code segment for incorporating automatically the client information, the estimate, the financing strategy, the number of draws, the amount of each draw, and the special contract term into a contract;
an editable worker database wherefrom a worker may be selected and assigned to the project;
an editable subcontractor database wherefrom a subcontractor may be identified and selected for the project;
an editable vendor database wherefrom a vendor may be selected for supplying the item selected from the list of items;
a code segment for generating, based upon information in the editable vendor database, an order form addressed to a specific vendor and ordering the item;
a code segment allowing for identification of any special considerations related to completing the project, including any special tools required to complete the project; and
a code segment for incorporating automatically the client information, the estimate, the number of draws, the amount of each draw, the worker, the subcontractor, the vendor, and the special considerations into a schedule for completing the project.
